(19) United States
(12) Patent Application Publication
(10) Pub. No.: US 2020/0126331 A1
(43) Pub. Date: Apr. 23, 2020

(54) OPERATION SYSTEM, ON-BOARD DEVICE, INDUSTRIAL VEHICLE, FORKLIFT, COMPUTER PROGRAM, DATA STRUCTURE, AND OPERATION METHOD

(71) Applicant: SUMITOMO ELECTRIC INDUSTRIES, LTD., Osaka-shi, Osaka (JP)

(72) Inventor: Yuri KISHITA, Osaka-shi (JP)

(73) Assignee: SUMITOMO ELECTRIC INDUSTRIES, LTD., Osaka-shi, Osaka (JP)

(21) Appl. No.: 16/618,497

(22) PCT Filed: Mar. 6, 2018
(86) PCT No.: PCT/JP2018/008516

§ 371 Date: Dec. 2, 2019

(30) Foreign Application Priority Data
Jun. 21, 2017 (JP) 2017-121665

(51) Int. Cl. G07C 5/08; B62D 41/00; B66F 9/075; B60R 25/00

(52) U.S. Cl. CPC G07C 5/0866; B62D 41/00; B60R 2325/308; B60R 25/00; B66F 9/0755

(57) ABSTRACT

An operation system includes: electronic keys; and an on-vehicle apparatus mounted on an industrial vehicle and to transmit and receive a signal to and from the electronic keys. The electronic keys include an output unit to output key information toward the on-vehicle apparatus. The on-vehicle apparatus includes a determination unit to determine, on the basis of acquired key information acquired, whether driving of the industrial vehicle having the on-vehicle apparatus mounted thereon is allowed, and an input unit to receive a video signal from an imaging apparatus to capture a video of a periphery of the industrial vehicle. When the determination unit has determined that the driving is allowed, the video corresponding to a predetermined time and captured before and after a timing of a trigger is stored in association with the key information, the trigger being a signal from a sensor to measure a status of the industrial vehicle.

### TECHNICAL FIELD

The present disclosure relates to an operation system, an on-vehicle apparatus, an industrial vehicle, a forklift, a computer program, a data structure, and an operation method. This application claims priority on Japanese Patent Application No. 2017-121665 filed on Jun. 21, 2017, the entire content of which is incorporated herein by reference.

### BACKGROUND ART

PATENT LITERATURE 1 discloses a driving recorder (imaging apparatus) that uses a wide-angle lens. This driving recorder is assumed to be mounted on a forklift.

### CITATION LIST

### Patent Literature

PATENT LITERATURE 1: Japanese Laid-Open Patent Publication No. 2016-143155

### SUMMARY OF INVENTION

An operation system of the present disclosure includes: a plurality of electronic keys; and an on-vehicle apparatus mounted on an industrial vehicle and configured to transmit and receive a signal to and from the plurality of electronic keys. The plurality of electronic keys each have key information stored therein, and include an output unit configured to output the key information toward the on-vehicle apparatus. The on-vehicle apparatus includes an acquisition unit configured to acquire key information outputted from the plurality of electronic keys, a determination unit configured to determine, on the basis of the acquired key information, whether or not driving of the industrial vehicle having the on-vehicle apparatus mounted thereon is allowed, and an input unit configured to receive a video signal from an imaging apparatus configured to capture a video of a periphery of the industrial vehicle. When the determination unit has determined that the driving is allowed, the on-vehicle apparatus stores the video corresponding to a predetermined time and captured by the imaging apparatus, in association with the key information, on the basis of a timing of a trigger which is a measurement result by a status measurement unit configured to measure a status of the industrial vehicle.

An on-vehicle apparatus of the present disclosure includes: an acquisition unit configured to acquire key information outputted from a plurality of electronic keys; a determination unit configured to determine, on the basis of the acquired key information, whether or not driving of an industrial vehicle having the on-vehicle apparatus mounted thereon is allowed; an input unit configured to receive a video signal from an imaging apparatus configured to capture a video of a periphery of the industrial vehicle; and a storage medium configured to store, when the determination unit has determined that the driving is allowed, the video corresponding to a predetermined time and captured by the imaging apparatus, in association with the key information, on the basis of a timing of a trigger which is a measurement result by a status measurement unit configured to measure a status of the industrial vehicle.

A computer program of the present disclosure is configured to cause a computer which receives a video signal from an imaging apparatus, to perform processes of: acquiring key information outputted from a plurality of electronic keys; determining, on the basis of the acquired key information, whether or not driving of an industrial vehicle having the computer mounted thereon is allowed; measuring a status of the industrial vehicle when it has been determined that the driving is allowed; and storing a video corresponding to a predetermined time and captured by the imaging apparatus, in association with the key information, on the basis of a timing of a trigger which is a measurement result.

A data structure of the present disclosure includes on-vehicle-apparatus-side key information configured to be used in an on-vehicle apparatus mounted on each of a plurality of industrial vehicles and to be stored for each industrial vehicle, and video data acquired from an imaging apparatus configured to capture a video of a periphery of the industrial vehicle. The data structure is configured to be used in processes of: acquiring key information outputted from a plurality of electronic keys; determining, on the basis of a correspondence with the acquired key information, whether or not driving of the industrial vehicle is allowed; and when it has been determined that the driving is allowed, storing the video, in the video data, that corresponds to a predetermined time based on a timing of a trigger, into a storage medium in association with the key information, the trigger being a measurement result by a status measurement unit configured to measure a status of the industrial vehicle.

An operation method of the present disclosure uses a plurality of electronic keys and an on-vehicle apparatus mounted on an industrial vehicle and configured to transmit and receive a signal to and from the plurality of electronic keys. In the operation method, the plurality of electronic keys each have key information stored therein and output the key information toward the on-vehicle apparatus. The on-vehicle apparatus receives a video signal from an imaging apparatus configured to capture a video of a periphery of the industrial vehicle and sequentially stores the video signal. When having acquired key information outputted from the plurality of electronic keys, the on-vehicle apparatus determines whether or not driving of the industrial vehicle having the on-vehicle apparatus mounted thereon is allowed, on the basis of the acquired key information. When the determination unit has determined that the driving is allowed, the on-vehicle apparatus stores the video, in the sequentially stored video signal, that corresponds to a predetermined time based on a timing of a trigger, in association with the key information, the trigger being a measurement result by a status measurement unit configured to measure a status of the industrial vehicle.

### BRIEF DESCRIPTION OF DRAWINGS

FIG. 1 illustrates the outline of a vehicle operation system of Embodiment 1.

FIG. 2A is a block diagram showing a configuration of the vehicle operation system of Embodiment 1.

FIG. 2B is a block diagram showing a configuration of the vehicle operation system of Embodiment 1.

FIG. 3 is a flow chart showing one example of the procedure of a storing process performed by an on-vehicle apparatus of Embodiment 1.

FIG. 4 is a block diagram showing a configuration of a vehicle operation system of Embodiment 2.

FIG. 5 is a flow chart showing one example of a procedure of a storing process performed by an on-vehicle apparatus of Embodiment 2.

FIG. 6 is a flow chart showing one example of a procedure of a storing process performed by the on-vehicle apparatus of Embodiment 2.

FIG. 7 illustrates the outline of a vehicle operation system of Embodiment 3.

FIG. 8 is a block diagram showing a configuration of the vehicle operation system of Embodiment 3.

FIG. 9 is a flow chart showing one example of a procedure of a video data storing process performed by an on-vehicle apparatus of Embodiment 3.

FIG. 10 is a flow chart showing one example of a procedure of a video data storing process performed by the on-vehicle apparatus of Embodiment 3.

FIG. 11 illustrates an example of the content of information stored in a communication apparatus of Embodiment 3.

FIG. 12 is a block diagram showing a configuration of a vehicle operation system of Embodiment 4.

FIG. 13 is a flow chart showing one example of a procedure of a storing process performed by an on-vehicle apparatus of Embodiment 4.

FIG. 14 is a flow chart showing one example of a procedure of a storing process performed by the on-vehicle apparatus of Embodiment 4.

FIG. 15 illustrates an example of the content of information stored in a communication apparatus of Embodiment 4.

### DESCRIPTION OF EMBODIMENTS

[Problem to be Solved by the Present Disclosure]

In the field of FA (Factory Automation), technological advancement of elements such as industrial robots and sensors is promoting further efficient manufacturing. Even in plants where processes are automated, industrial transport vehicles such as forklifts driven by operators are used in many cases for supplying parts, collecting and distributing process-completed articles, sending products into a distribution center, loading products onto a delivery vehicle, and the like.

As for a transport vehicle, an operator who drives the transport vehicle determines what and how to transport at a work site allocated to the operator. Therefore, in a site where a plurality of transport vehicles are present, redundancy of objects to be transported and accidents such as collision could occur.

Driving recorders that can capture an image of a collision accident so as to deter an accident, and that can keep an evidence image if an accident has occurred, are prevalent.

Usage of a driving recorder for an industrial transport vehicle such as a forklift is different from that for a general passenger car. For an industrial vehicle, not only determent of an accident as described above but also operation along an efficient movement line are required. Therefore, it is desired that data is collected using a camera of a driving recorder, and the movement line of the vehicle and the location of the operator as the driver are comprehensively managed by using the video data and other information.

An object of the present disclosure is to provide an operation system, an on-vehicle apparatus, an industrial vehicle, a forklift, a computer program, a data structure, and an operation method that enable efficient use of an industrial vehicle by use of a driving recorder.

[Description of Embodiment of the Present Disclosure]

First, embodiments of the present disclosure are listed and described. At least some parts of the embodiments described below may be combined as desired.

An operation system of the present embodiment includes: a plurality of electronic keys; and an on-vehicle apparatus mounted on an industrial vehicle and configured to transmit and receive a signal to and from the plurality of electronic keys. The plurality of electronic keys each have key information stored therein, and include an output unit configured to output the key information toward the on-vehicle apparatus. The on-vehicle apparatus includes an acquisition unit configured to acquire key information outputted from the plurality of electronic keys, a determination unit configured to determine, on the basis of the acquired key information, whether or not driving of the industrial vehicle having the on-vehicle apparatus mounted thereon is allowed, and an input unit configured to receive a video signal from an imaging apparatus configured to capture a video of a periphery of the industrial vehicle. When the determination unit has determined that the driving is allowed, the on-vehicle apparatus stores the video corresponding to a predetermined time and captured by the imaging apparatus, in association with the key information, on the basis of a timing of a trigger which is a measurement result by a status measurement unit configured to measure a status of the industrial vehicle.

An on-vehicle apparatus of the present embodiment includes: an acquisition unit configured to acquire key information outputted from a plurality of electronic keys; a determination unit configured to determine, on the basis of the acquired key information, whether or not driving of an industrial vehicle having the on-vehicle apparatus mounted thereon is allowed; an input unit configured to receive a video signal from an imaging apparatus configured to capture a video of a periphery of the industrial vehicle; and a storage medium configured to store, when the determination unit has determined that the driving is allowed, the video corresponding to a predetermined time and captured by the imaging apparatus, in association with the key information, on the basis of a timing of a trigger which is a measurement result by a status measurement unit configured to measure a status of the industrial vehicle.

An industrial vehicle of the present embodiment has the on-vehicle apparatus described above mounted thereon.

In the present embodiment, the industrial vehicle may be a forklift.

A computer program of the present embodiment is configured to cause a computer which receives a video signal from an imaging apparatus, to perform processes of: acquiring key information outputted from a plurality of electronic keys; determining, on the basis of the acquired key information, whether or not driving of an industrial vehicle having the computer mounted thereon is allowed; measuring a status of the industrial vehicle when it has been determined that the driving is allowed; and storing a video corresponding to a predetermined time and captured by the imaging apparatus, in association with the key information, on the basis of a timing of a trigger which is a measurement result.

An operation method of the present embodiment uses a plurality of electronic keys and an on-vehicle apparatus mounted on an industrial vehicle and configured to transmit and receive a signal to and from the plurality of electronic keys. In the operation method, the plurality of electronic keys each have key information stored therein and output the key information toward the on-vehicle apparatus. The on-vehicle apparatus receives a video signal from an imaging apparatus configured to capture a video of a periphery of the industrial vehicle and sequentially stores the video signal. When having acquired key information outputted from the plurality of electronic keys, the on-vehicle apparatus determines whether or not driving of the industrial vehicle having the on-vehicle apparatus mounted thereon is allowed, on the basis of the acquired key information. When the determination unit has determined that the driving is allowed, the on-vehicle apparatus stores the video, in the sequentially stored video signal, that corresponds to a predetermined time based on a timing of a trigger, in association with the key information, the trigger being a measurement result by a status measurement unit configured to measure a status of the industrial vehicle.

In the operation system of the present embodiment, the on-vehicle apparatus is mounted in an industrial vehicle and transmits and receives a signal to and from a corresponding electronic key. The type of transmission and reception of the signal may be a passive radio wave type in which a radio wave corresponding to a frequency band of a UHF band or the like of a radio signal is received, or an electromagnetic induction type in which an antenna coil is provided and a signal from an electronic key is demodulated via the antenna coil. Other than this, any configuration may be employed in which information can be transmitted and received with each other.

The on-vehicle apparatus determines whether or not driving of an industrial vehicle is allowed on the basis of the key information outputted from the electronic key. The output unit may transmit the key information to the on-vehicle apparatus by means of a radio signal, may output the key information by displaying characters or a two-dimensional bar code, or may output the key information by means of sound. Meanwhile, the acquisition unit on the on-vehicle apparatus side may acquire the key information by receiving the radio signal, by capturing a video of the displayed characters or two-dimensional bar code, or by receiving the outputted sound.

The on-vehicle apparatus further receives a video signal from an imaging apparatus configured to capture a video of the periphery of an industrial vehicle having the on-vehicle apparatus mounted thereon. With a view to capturing an image of an object or a person present in the periphery of a vehicle at each time point during driving, the imaging apparatus captures a video of the periphery of the vehicle. Preferably, the periphery is the entire circumference of 360 degrees, but not limited thereto. When it has been determined that the driving is allowed on the basis of the acquired key information, the on-vehicle apparatus stores a video corresponding to a predetermined time based on a received video signal, triggered by a measurement result by a status measurement unit which measures the status of the vehicle, such as a sensor mounted on the industrial vehicle or a driving control device. The video is stored in association with the key information based on which it has been determined that the driving is allowed. The video is stored into a storage unit of the on-vehicle apparatus itself, an external memory, another storage device via a communication unit, or the like.

In the operation system of the present embodiment, the status measurement unit includes at least one of a vehicle speed sensor, an acceleration sensor, a weight sensor, or an infrared sensor.

The trigger for storing the video is a measurement result of a status of the vehicle by the status measurement unit. For example, as the status measurement unit, a sensor mounted in the industrial vehicle is used. Examples of the sensor include a vehicle speed sensor, an acceleration sensor, a weight sensor, an infrared sensor, and the like, but not limited thereto. Using a measurement result from at least one of these sensors, for example, using detection of overspeed or an impact as a trigger, the video is stored together with key identification information or user identification information that can specify the driver in a later time. The weight of an object to be transported, the weight of the driver, or the like that can be measured by a weight sensor may be used. Alternatively, using an infrared sensor that measures the distance from the vehicle body to the periphery, a change in the distance may be used as a trigger. The distance need not necessarily be measured by an infrared sensor, and may be measured on the basis of the size (the area in a captured image (frame image)) of a specific object captured by a camera.

The status measurement unit may be a drive control device or the like, and the trigger may be information that indicates a driving status. In this case, for example, the on-vehicle apparatus may store the video, using as a trigger a change in the position of the ignition key, the gear position, a tilt of the vehicle, the steering angle, or the like. Other than this, the status measurement unit may be a device or the like that acquires position information of the vehicle.

In the operation system of the present embodiment, the industrial vehicle is a forklift, and the status measurement unit includes a weight sensor provided at a fork portion of the forklift and configured to measure the weight of an object to be transported. The on-vehicle apparatus stores the video corresponding to the predetermined time, using a change in the measured weight as a trigger.

When the industrial vehicle is limited to a forklift, a weight sensor that is provided at the fork portion and can measure the weight of an object to be transported can be used as a trigger for storing the video. If a change in the weight measured by the weight sensor is used as a trigger, in a case of a status for which dropping is suspected during traveling of the forklift, such as when the measured weight suddenly decreases, for example, it is possible to store the video that allows a posteriori inference of the cause of the drop.

In the operation system of the present embodiment, the on-vehicle apparatus further includes an image processing unit configured to perform image processing on the video signal from the imaging apparatus, and stores the video corresponding to the predetermined time when, as a result of image processing performed by the image processing unit, it is determined that a specific object or person has been captured in a video based on the video signal.

The image processing unit performs image processing on the video signal from the imaging apparatus which captures a video of the periphery. With respect to a frame image based on the video signal, the image processing unit may determine whether a specific object or person has been captured in the video, on the basis of arrangement, size, and pattern matching and the like of colors.

As a result of the process in the image processing unit, when it can be determined that a specific object or person has been captured in the video (the region has been extracted), the on-vehicle apparatus stores the video, considering this determination as a measurement result indicating the status of the vehicle, i.e., a trigger. If the specific object is associated with position information, it becomes possible to detect the positions passed by the industrial vehicle, i.e., the movement line, in a later time.

The operation system of the present embodiment further includes a communication apparatus configured to receive the video corresponding to the predetermined time, through communication from the on-vehicle apparatus or via one of the electronic keys. The communication apparatus includes a storage unit configured to store the received video in association with: vehicle identification information of the industrial vehicle having the on-vehicle apparatus mounted thereon; and driver identification information of a driver specified from the key information.

The video is stored in the communication apparatus which communicates, directly or via a communication means of the electronic key, with the on-vehicle apparatus. The video can be transmitted from the on-vehicle apparatus of a plurality of the industrial vehicles. In the communication apparatus, videos captured in the plurality of the industrial vehicles are each stored together with driver identification information which specifies a driver specified from the key information. It is possible to specify a posteriori or in real time which operator drove or is driving the industrial vehicle whose periphery was captured in the video that corresponds to the video data.

A data structure of the present embodiment includes on-vehicle-apparatus-side key information configured to be used in an on-vehicle apparatus mounted on each of a plurality of industrial vehicles and to be stored for each industrial vehicle, and video data acquired from an imaging apparatus configured to capture a video of a periphery of the industrial vehicle. The data structure is configured to be used in processes of: acquiring key information outputted from a plurality of electronic keys; determining, on the basis of a correspondence with the acquired key information, whether or not driving of the industrial vehicle is allowed; and when it has been determined that the driving is allowed, storing the video, in the video data, that corresponds to a predetermined time based on a timing of a trigger, into a storage medium in association with the key information, the trigger being a measurement result by a status measurement unit configured to measure a status of the industrial vehicle.

In the present embodiment, on the basis of a trigger, the video data is stored in association with vehicle identification information or key information based on which it has been determined that driving is allowed. Accordingly, for each vehicle, or for each operator who is the driver specified from the key information, it is possible to analyze the driving status while making distinct which electronic key the operator held and which industrial vehicle the operator drove. Thus, management of the movement line or deployment of goods or operators in accordance with the driving status can be realized.

The present disclosure can be realized as a semiconductor integrated circuit that realizes a part or the entirety of the operation system having such a characteristic selection unit, the on-vehicle apparatus, and processes in the operation method, or can be realized as another system that exhibits functions as a result of the operation system cooperating with still another apparatus. In addition, the present disclosure can be realized as a storage medium having stored therein a computer program and operation data that perform characteristic processes.

[Effect of the Present Disclosure]

According to the present disclosure, efficient use of an industrial vehicle including a forklift can be realized.

[Detailed Description of Embodiments of the Present Disclosure]

Hereinafter, an operation system for an industrial vehicle according to the present disclosure will be described with reference to the drawings which show embodiments. In the embodiments below, examples of a vehicle operation system for realizing operation management of, as an industrial vehicle, a forklift which is a transport vehicle are described.

### Embodiment 1

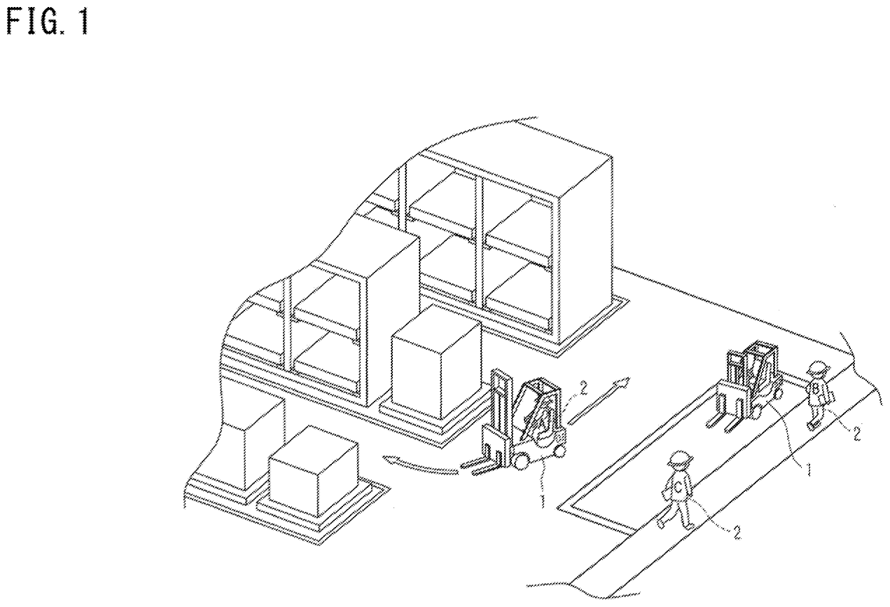

FIG. 1 illustrates the outline of a vehicle operation system of Embodiment 1. In Embodiment 1, first, by use of electronic keys 2, only authorized operators who are allowed to hold the electronic keys 2 can be drivers. In addition, key identification information stored in the electronic key 2 for individually identifying the electronic key 2 itself, and operator identification information of an operator holding the key, are associated with each other. Thus, it is possible to store the status of each forklift 1 such that which operator holds which electronic key 2 and has driven which forklift 1 can be made distinct. With reference to FIG. 1 as an example, an operator A, an operator B, and an operator C each hold an electronic key 2. Each electronic key 2 has stored therein key identification information for individually identifying the electronic key 2 itself. If in association with key identification information, operator identification information of an operator holding a corresponding key is stored in a communication apparatus, it is possible to specify which operator holds which electronic key 2 and has driven which forklift 1, and further, which image or moving image corresponds thereto. For example, with respect to one forklift 1, the operator B who has ended work using this forklift 1 and the operator C who is to use the forklift 1 can be made distinct from each other on the basis of key identification information stored in the respective electronic keys 2 held by the operator B and the operator C.

In the vehicle operation system of Embodiment 1, a camera is mounted on each forklift 1, and the camera captures a video (image or moving image) of places forward and rearward of the forklift 1. Thus, it is possible to store the status at the time of detection of collision in the work site, detection of a danger before occurrence of an accident, such as sudden start or sudden braking, and the like. In the vehicle operation system of Embodiment 1, further, the status according to a video captured by a camera is stored in association with information of an electronic key 2 for driving the forklift 1, whereby the status is associated with information for identifying the holder of the electronic key 2. The video captured by the forklift 1 is stored in association with the information for identifying the holder of the electronic key 2, i.e., the driver, and thus, if this is collected, the movement lines of the respective forklifts 1 and the deployment of the operators as the drivers can be comprehensively managed.

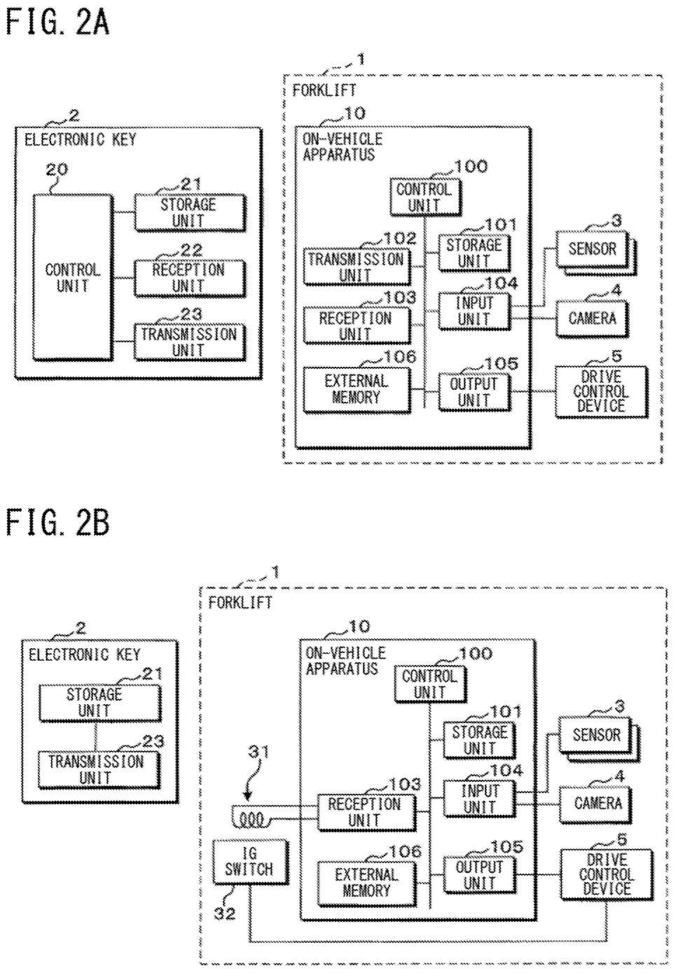

FIG. 2A and FIG. 2B are each a block diagram showing a configuration of a vehicle operation system of Embodiment 1. The vehicle operation system includes an on-vehicle apparatus 10 incorporated in a forklift 1, and an electronic key 2. FIG. 2A shows a passive radio wave type in which an inquiry is made from the on-vehicle apparatus 10 side to the electronic key 2. FIG. 2B shows an electromagnetic induction type in which a signal emitted from an electronic key 2 inserted in a key cylinder is received on the on-vehicle apparatus 10 side.

The on-vehicle apparatus 10 includes a control unit 100, a storage unit 101, a transmission unit 102, a reception unit 103, an input unit 104, an output unit 105, and an external memory 106. The control unit 100 is, for example, a microcontroller that uses one or a plurality of CPUs (Central Processing Unit) or a multicore CPU and that includes a ROM (Read Only Memory), a RAM (Random Access Memory), an input/output interface, a timer, and the like. The control unit 100 is a determination unit which controls operation of components by executing a control program stored in a built-in ROM, and which performs determination as to whether or not driving is allowed, which is described later.

The storage unit 101 is a nonvolatile storage medium (memory) such as a flash memory or an EEPROM (Electrically Erasable Programmable Read-Only Memory). The storage unit 101 has stored therein information for determining whether or not driving by a driver holding an electronic key 2 is allowed (rewritable), and vehicle identification information for mutually identifying forklifts 1 (non-rewritable). The storage unit 101 of the on-vehicle apparatus 10 in Embodiment 1 has stored therein key identification information for uniquely identifying an electronic key 2, as information for determining that driving is allowed (key information). For example, in a case where one forklift 1 is allowed to be shared by three people, i.e., the operator A, the operator B, and the operator C, all of the key identification information of the electronic keys 2 held by the three people is stored in the storage unit 101.

The transmission unit 102 is a circuit that modulates, by using a carrier wave, a signal provided from the control unit 100 and transmits a radio signal from a transmission antenna. As a frequency band for the carrier wave, the transmission unit 102 uses a Low Frequency band (LF band) of 30 kHz to 300 MHz, or a Very Low Frequency band (VLF band) of 3 kHz to 30 kHz. An output power of a signal from the transmission unit 102 is set such that the body of an operator driving in the driver's seat of a forklift 1 is included in a range around the antenna of the transmission unit 102, for example. That is, communication with only the electronic key 2 held by a driver present in the driver's seat is allowed.

The reception unit 103 is a circuit that receives, via an antenna, a signal in an Ultra High Frequency band (UHF band, also referred to as RF band) of 300 MHz to 3 GHz and demodulates the signal, and outputs the modulated signal to the control unit 100. The control unit 100 functions an acquisition unit that acquires, by using the reception unit 103, key information transmitted from each of the electronic keys 2.

The input unit 104 is an interface that receives a signal from outside of the on-vehicle apparatus 10. The control unit 100 can receive information from outside through the input unit 104. A sensor-3 group and a camera 4 are connected to the input unit 104. The control unit 100 can acquire information from the sensor-3 group through the input unit 104, and can receive a video signal from the camera 4.

The output unit 105 is an interface that outputs a signal indicating whether or not driving is allowed, to a drive control device 5. The output unit 105 may be a communication unit connected to an in-vehicle LAN (Local Area Network), and in this case, may serve as a communication unit in combination with the input unit 104.

The external memory 106 is provided separately from the storage unit 101, and an SD memory card is used, for example. While the on-vehicle apparatus 10 itself is provided inside the interior equipment of the forklift 1, the external memory 106 is a small memory that can be inserted into/pulled out of a place by a manager of the forklift 1.

In a case where transmission/reception of a signal between the on-vehicle apparatus 10 and the electronic key 2 is of the electromagnetic induction type shown in FIG. 2B, the on-vehicle apparatus 10 does not have the transmission unit 102, compared with the passive type shown in FIG. 2A. In the case of the electromagnetic induction type, the reception unit 103 demodulates a signal read out through an antenna coil 31 provided at a key cylinder.

As the sensors 3, a plurality of various sensors, such as a vehicle speed sensor for measuring a vehicle speed and an acceleration sensor for detecting an impact to the vehicle body, are used. The sensor-3 group is a generic term for these, and corresponds to a status measurement unit which measures the status of the vehicle.

The camera 4 includes a first camera provided at a front portion of the forklift 1 and facing forward to capture a video, and a second camera provided at a rear portion of the forklift 1 and facing rearward to capture a video. Each of the first camera and the second camera has a wide-angle lens, and the angle of view is set to 360 degrees around in order to capture a video of all objects and persons present in the periphery of the forklift 1. Preferably, the first camera and the second camera have sufficient durability with dust-proof and water-proof characteristics. The camera 4 may be realized by one camera, and a special mirror and a lens that allow capture of a video of 360 degrees. The control unit 100 of the on-vehicle apparatus 10 sequentially stores, as video data into the storage unit 101, a video signal received through the input unit 104 from the camera 4. The control unit 100 sequentially overwrites old video data with new video data. The camera 4 may have an internal memory, video data based on the video signal may be sequentially stored in this internal memory so that older data is sequentially overwritten, and the video data may be readable by the control unit 100.

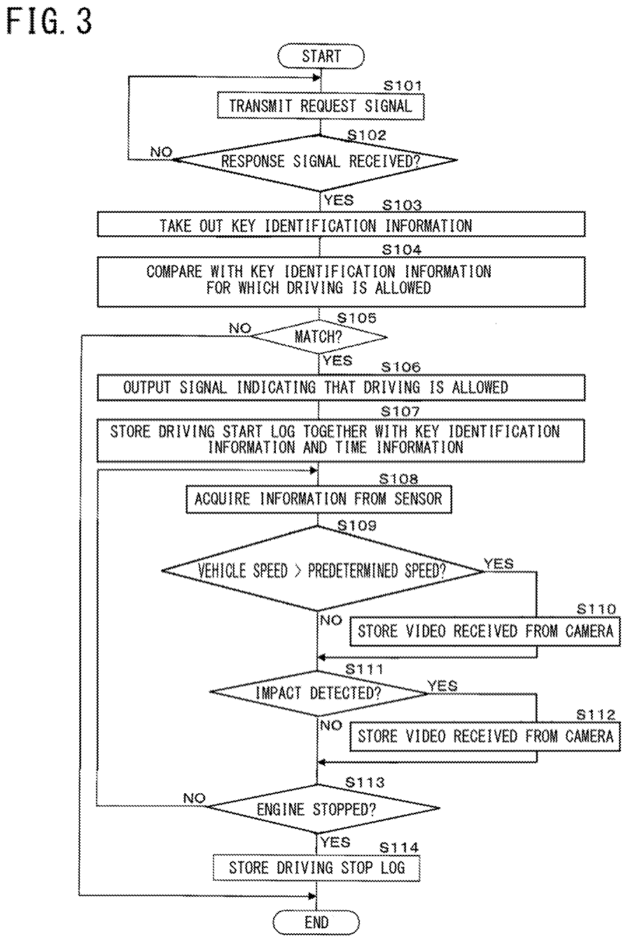

The drive control device 5 is a device that controls driving performed by an engine or drive motor of the forklift 1. The drive control device 5 can cause the engine or drive motor to start on the basis of: the state of an ignition switch or a power-on switch; and a signal outputted by the on-vehicle apparatus 10 and indicating whether or not driving is allowed. The drive control device 5 can also cause automatic stop or the like in accordance with the state. In a case of the electromagnetic induction type shown in FIG. 3, the drive control device 5 detects the state of the ignition switch on the basis of the position of the key in the key cylinder.

The electronic key 2 includes a control unit 20, a storage unit 21, a reception unit 22, and a transmission unit 23. The control unit 20 is, for example, a microcontroller that uses one or a plurality of CPUs or a multicore CPU and that includes a ROM, a RAM, an input/output interface, a timer, and the like.

As the storage unit 21, a non-volatile memory such as a flash memory or an EEPROM is used. The storage unit 21 has stored therein unique key identification information (non-rewritable) for identifying each electronic key 2. In Embodiment 1, the key identification information is used as information (key information) for determining whether or not driving is allowed, which is described later. As the key information, other information (identification information of the driver holding the key, key information provided in advance) that is different from the key identification information, may be stored.

As the reception unit 22, a module including a demodulator and a reception antenna corresponding to the transmission unit 102 of the on-vehicle apparatus 1 is used. The frequency band used by the reception unit 22 is an LF band or a VLF band. It is understood that the frequency band is not limited to these frequency bands as long as the frequency band corresponds to that of the transmission unit 102 of the mobile apparatus 1.

The transmission unit 23 is connected to a transmission antenna for the frequency corresponding to that of the reception unit 103 of the on-vehicle apparatus 1. As the transmission unit 23, a module including a modulator that modulates a signal to be transmitted via the transmission antenna is used. The frequency band used by the transmission unit 23 is a UHF band (RF band). It is understood that the frequency band is not limited to this frequency band as long as the frequency band corresponds to that of the reception unit 103 of the on-vehicle apparatus 1.

When having detected reception of a request signal from the on-vehicle apparatus 1, the control unit 20 of the electronic key 2 causes key identification information stored in the storage unit 21 to be included in a response signal and transmits the response signal. The control unit 20 functions as an output unit that outputs key information toward the on-vehicle apparatus 1 by using the transmission unit 23.

In a case where transmission/reception of a signal between the on-vehicle apparatus 10 and the electronic key 2 is of the electromagnetic induction type shown in FIG. 2B, the electronic key 2 does not have the control unit 20 and the reception unit 22 compared with the passive type shown in FIG. 2A. In the case of the electromagnetic induction type, the transmission unit 23 is a transponder coil. When a key portion of the electronic key 2 is inserted in the key cylinder of the vehicle, key information, which is key identification information or other information, is read out from the storage unit 21 from the on-vehicle apparatus 1 side.

A procedure of a storing process of an image or a moving image captured by the camera 4 in the system configured as above is described with reference to a flow chart. FIG. 3 is a flow chart showing one example of the procedure of a storing process performed by the on-vehicle apparatus 10 of Embodiment 1. In a state where the engine (or drive motor) of the forklift 1 is stopped, the control unit 100 of the on-vehicle apparatus 10 performs the following processes. This process procedure indicated by the flow chart in FIG. 3 corresponds to a case where the electronic key 2 of the passive radio wave type is used.

The control unit 100 periodically transmits, through the transmission unit 102, a request signal for confirming whether or not an electronic key 2 is present in the output range (step S101). The control unit 100 determines whether or not a response signal corresponding to the request signal has been received by the reception unit 103 (step S102). Upon determining that the response signal has not been received (S102: NO), the control unit 100 returns the process to step S101.

Upon determining in step S102 that the response signal has been received (S102: YES), the control unit 100 takes out key information included in the received response signal (key identification information of the electronic key 2) (step S103). In a case where other information for determining whether or not driving is allowed is included in the response signal, the control unit 100 may also take out this information in step S103.

The control unit 100 compares the key information taken out in step S103, i.e., the key identification information of the electronic key 2, with key identification information which is stored in the storage unit 101 and for which it is to be determined that driving is allowed (step S104), and determines whether or not the taken-out key identification information matches the key identification information for which it is to be determined that driving is allowed (step S105). Upon determining there is no matching therebetween in step S105 (S105: NO), the control unit 100 ends the process.

In step S105, in a case where it is determined that driving is not allowed although the response signal has been received, if a user interface such as a sound output unit or a display that can be confirmed by a driving operator is provided, a message may be outputted from the output unit 105 such that a message/sound indicating that driving is not permitted is displayed/outputted through the interface. Further, in this case, the control unit 100 may output a signal indicating that driving is not allowed, through the output unit 105 to the drive control device 5. The drive control device 5 having received the signal indicating that driving is not allowed may prohibit operations, e.g., not allowing start of the engine (or drive motor), prohibiting traveling even if the engine is allowed to start, or not allowing gear change or steering operation.

Upon determining that there is matching therebetween in step S105 (S105: YES), the control unit 100 outputs a signal indicating that driving is allowed, through the output unit 5 toward the drive control device 5 (step S106). Then, the engine or drive motor is started by the drive control device 5, whereby driving is enabled. For outputting a signal indicating that driving is allowed in step S106, a weight sensor may be provided at a seat in a case of a counter-type forklift 1 or a standing position in a case of a reach-type forklift 1 to detect whether or not a person is seated or whether or not a person is standing at the standing position, and the signal may be outputted only when a person is seated or present in an appropriate attitude at the standing position.

Next, the control unit 100 stores log data indicating that driving has started, into the external memory 106, in association with key identification information corresponding to the electronic key 2 held by the driver and time information (time stamp) acquired by a built-in timer (step S107). In step S107, the vehicle identification information of the forklift 1 may be stored in association with the log data.

Then, the control unit 100 acquires information from the sensor-3 group (step S108) and determines whether or not the vehicle speed acquired from the vehicle speed sensor has exceeded a predetermined speed (step S109). Upon determining that the vehicle speed has exceeded the predetermined speed (S109: YES), the control unit 100 stores, into the external memory 106, video data corresponding to a predetermined time in the video data received from the camera 4 and sequentially stored in the storage unit 101, in association with the key identification information and time information acquired by the built-in timer (step S110), and advances the process to step S111. The video data corresponding to the predetermined time includes video data before the timing at which it has been determined that the vehicle speed has exceeded the predetermined speed in step S109, and includes video data after that timing. The predetermined time is, for example, several ten seconds to several minutes before and after the timing of the determination. Upon determining that the vehicle speed is not greater than the predetermined speed (S109: NO), the control unit 100 advances the process to step S111.

On the basis of an acceleration value indicated by the acceleration sensor included in the sensor-3 group, the control unit 100 determines whether or not an impact has been detected (step S111). At this time, the impact is detected as a collision with another forklift 1, riding onto a step, sudden braking, sudden start, or the like. Upon determining that the impact has been detected (S111: YES), the control unit 100 stores, into the external memory 106, video data in association with the key identification information and time information (step S112), and advances the process to step S113. The process in step S112 is the same as that in step S110. Upon determining that no impact has been detected (S111: NO), the control unit 100 advances the process to step S113.

The control unit 100 determines whether or not the engine has stopped (step S113). In step S113, for example, the control unit 100 makes the determination according to whether or not the power-on switch has entered an OFF-state in a case of the passive radio wave type, and the control unit 100 makes the determination according to whether or not the ignition switch has entered an OFF-state in a case of the electromagnetic induction type. In a case where the forklift 1 is operated by a drive motor, the control unit 100 may determine whether or not the power switch has entered an OFF-state.

When having determined that the engine has not stopped (S113: NO), the control unit 100 returns the process to step S108 after a predetermined waiting time, and repeats acquisition of information from the sensor-3 group and the determination processes based on the acquired information.

When having determined that the engine has stopped (S113: YES), the control unit 100 stores, into the external memory 106, log data indicating that the driving has ended, in association with the key identification information and time information acquired by the built-in timer (step S114), and ends the process.

In a case where the electronic key 2 and the on-vehicle apparatus 10 of the electromagnetic induction type are used, step S101 and step S102 are not necessary, and the control unit 100 takes out key identification information through the reception unit 103 in step 103.

Due to the process procedure described above, only the forklift 1 on which an operator holding an appropriate electronic key 2 is present is allowed to be driven, and video data (moving image) can be stored with the operator driving the forklift 1 being distinct. For example, once a day, a manager takes out the external memory 106 from the on-vehicle apparatus 10 for each forklift 1 and reads out the data stored therein. The read-out data includes log data from a driving start log to a driving end log and a video at the time of detection of overspeed or an impact, of each driving. Since key identification information is communicated between the electronic key 2 and the on-vehicle apparatus 10, even if a different electronic key 2 is used, the forklift 1 is allowed to be driven, and thus, convenience is improved. In a case of the passive type, only if the operator holds an electronic key 2, the operator can drive the forklift 1, and thus, convenience is improved. In addition, logs and video data corresponding to overspeed or an impact of each driving are stored while their corresponding electronic key 2, i.e., the driving operator, is identified. Even if operators drive different forklifts 1, it is possible to analyze, for each operator, the driving tendency for each different forklift 1.

### Embodiment 2

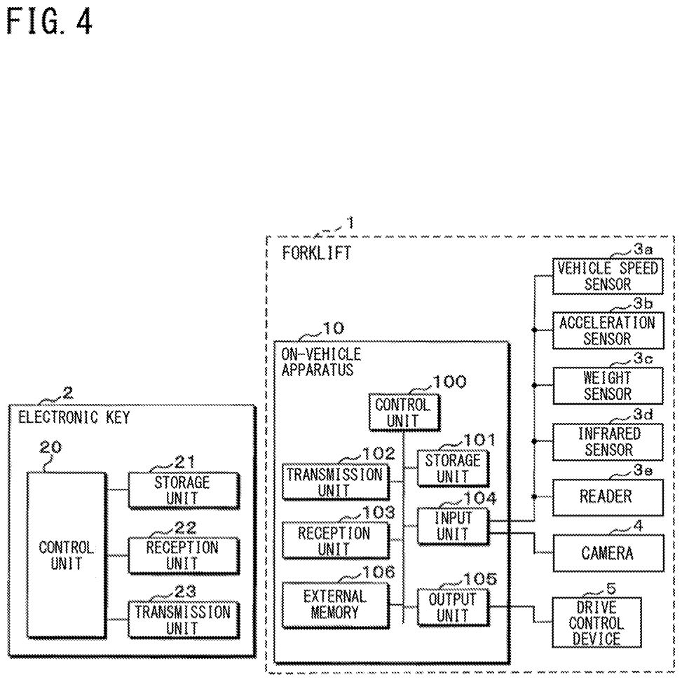

FIG. 4 is a block diagram showing a configuration of a vehicle operation system of Embodiment 2. The sensor-3 group (status measurement unit) in Embodiment 2 includes a weight sensor 3c, an infrared sensor 3d, a radio tag reader 3e, in addition to a vehicle speed sensor 3a and an acceleration sensor 3b. Since the other configurations are the same as those of the vehicle operation system of Embodiment 1, common configurations are denoted by the same reference signs, and detailed description thereof is omitted. In FIG. 4 and the description below, an example using the electronic key 2 of the passive radio wave type is described. However, the electronic key 2 and the on-vehicle apparatus 10 of the electromagnetic induction type may be used.

The vehicle speed sensor 3a is a sensor that is mounted near the engine or a tire of the forklift 1 and that measures a vehicle speed. The acceleration sensor 3b is a triaxial sensor that is mounted to a place in the vehicle body or a fork portion. The weight sensor 3c is a sensor that measures a load on the fork portion of the forklift 1, and outputs a signal level corresponding to the load. The infrared sensor 3d is, for example, a sensor unit having a red semiconductor laser and a CMOS (Complementary Metal Oxide Semiconductor) sensor, and measures the distance to a closest object. For example, the infrared sensor 3d is provided at a fork end of the forklift 1, measures the distance from the fork end to a closest object, and outputs a signal level corresponding to the distance. The infrared sensor 3d may be provided at a plurality of places in the vehicle body so as to be used for collision avoidance. The reader 3e is a device that reads information from a storage medium provided in a radio tag. For example, the reader 3e is an RFID (Radio Frequency Identifier) reader and reads out information from an RFID tag attached to an object to be transported.

In Embodiment 2, the control unit 100 of the on-vehicle apparatus 10 stores video data using, as a trigger, not only determination as to whether the vehicle speed acquired from the vehicle speed sensor 3a has exceeded a predetermined speed or as to whether an impact acquired from the acceleration sensor 3b has been detected, but also information from other sensors in the sensor-3 group. For example, the control unit 100 performs the storing using, as a trigger, a load weight on the fork portion measurable by the weight sensor 3c, a distance to a peripheral object and a distance from the vehicle body to a person or object present in the periphery measurable by the infrared sensor 3, and information of an object to be transported read by the reader 3e.

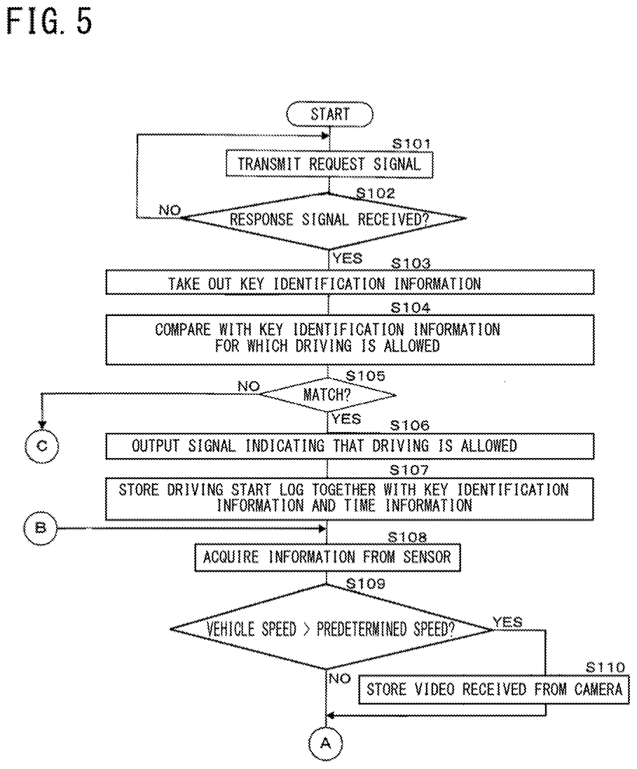

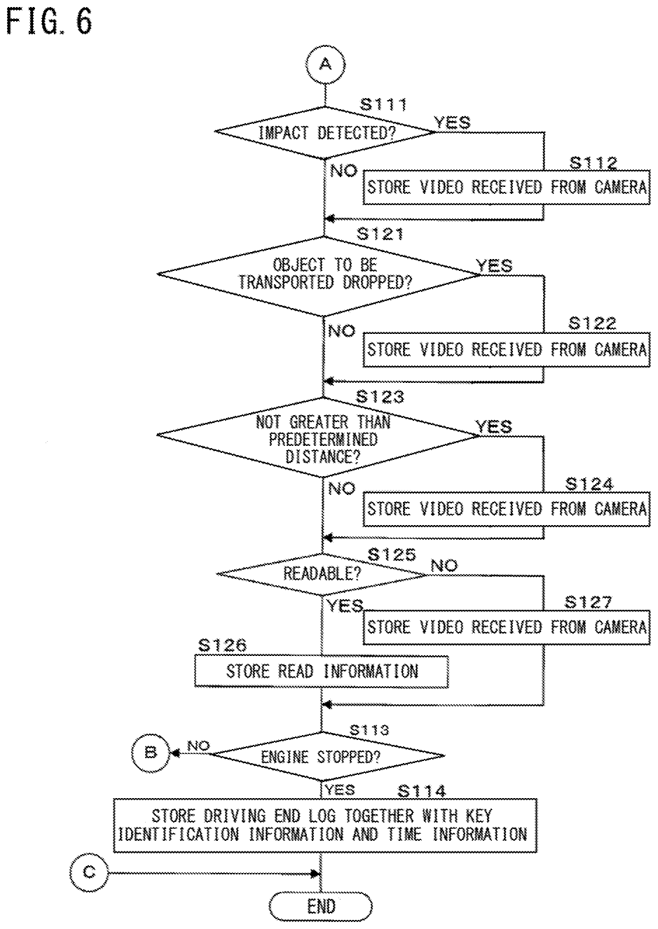

FIG. 5 and FIG. 6 are each a flow chart showing one example of a procedure of a storing process performed by the on-vehicle apparatus 10 of Embodiment 2. In the process procedure shown in the flow chart of FIG. 5 and FIG. 6, process steps that are the same as those in the flow chart in FIG. 3 of Embodiment 1 are denoted by the same step numbers, and detailed description thereof is omitted.

In Embodiment 2, in step S108, the control unit 100 acquires information from one of, a plurality of, or all of the vehicle speed sensor 3a, the acceleration sensor 3b, the weight sensor 3c, the infrared sensor 3d, and the reader 3e (S108). Upon determining in step S111 that no impact has been detected (S111: NO), or after determining that an impact has been detected and storing video data (S112), the control unit 100 determines whether or not an object to be transported has dropped during transportation on the basis of the vehicle speed acquired from the vehicle speed sensor 3a and the load weight acquired from the weight sensor 3c (step S121). In step S121, for example, when it is possible to determine that the load on the fork portion has suddenly decreased although the vehicle speed is not zero, i.e., the forklift 1 has not stopped, dropping is suspected (step S121: YES). Thus, the control unit 100 stores video data (step S122). After storing the video data, the control unit 100 advances the process to step S123. Other than this, in step S121, when it is possible to determine that the load has suddenly decreased although the gear position is not at a stop position for loading or unloading of an object to be transported, the control unit 100 may determine dropping has occurred. When there is no change in the load and it is determined that no dropping has occurred (S121: NO), the control unit 100 advances the process to step S123.

In the storing process in step S122, similar to the process in step S110 described in Embodiment 1, the control unit 100 stores, into the external memory 106, video data corresponding to a predetermined time in the video data received from the camera 4 and sequentially stored in the storage unit 101, in association with the key identification information and time information acquired by the built-in timer.

Then, the control unit 100 determines whether or not the distance acquired from the infrared sensor 3d is not greater than a predetermined distance (step S123). Upon determining that the distance is not greater than the predetermined distance (S123: YES), the control unit 100 stores video data (step S124), and advances the process to step S125. In step S123, when it is determined that the distance is not greater than the predetermined distance, there is a possibility that loading, unloading, or the like of the object to be transported is performed while the distance is not greater than the predetermined distance. Therefore, in this case, if video data is stored, a video regarding handling of the object to be transported can be recorded. The storing process in step S124 is the same as that in step S110. When having determined that the distance is greater than the predetermined distance in step S123 (S123: NO), the control unit 100 advances the process to step S125.

The control unit 100 determines whether or not information has been able to be read by the reader 3e from the object to be transported (step S125). Upon determining that information has been able to be read (readable) (S125: YES), the control unit 100 stores, into the external memory 106, the read information in association with the key identification information (step S126), and advances the process to step S113. When having determined that information has not been able to be read (S125: NO), the control unit 100 stores video data (step S127), and advances the process to step S113. In this case, a video regarding an unknown object to be transported can be recorded.

The determinations for storing videos based on information acquired from the sensor-3 group shown in the flow chart in FIG. 5 and FIG. 6 are merely examples. The process of storing video data depending on whether or not information has been able to be read by the reader 3e, and the process based on measurement of the distance by the infrared sensor 3d are also merely examples. Any of these processes may be combined together as appropriate. Alternatively, these process may be replaced by other determination processes. However, different from an external driving recorder that could also be applied to a passenger car, the on-vehicle apparatus 10 in Embodiment 2 uses information unique to the forklift 1, i.e., in the example described above, the load on the fork portion, information of an object to be transported, and the distance to an object (or a person) that is approaching, and the like. The on-vehicle apparatus 10 is incorporated in the forklift 1 in advance, and connected to the drive control device 5, and can acquire information indicating the status of the vehicle. Storing of video data may be triggered in accordance with the status of the forklift 1 (status of vehicle) which is estimated on the basis of information acquired from the sensor-3 group and other information such as a gear position mentioned as an example in step S121, without being limited to information from sensors.

### Embodiment 3

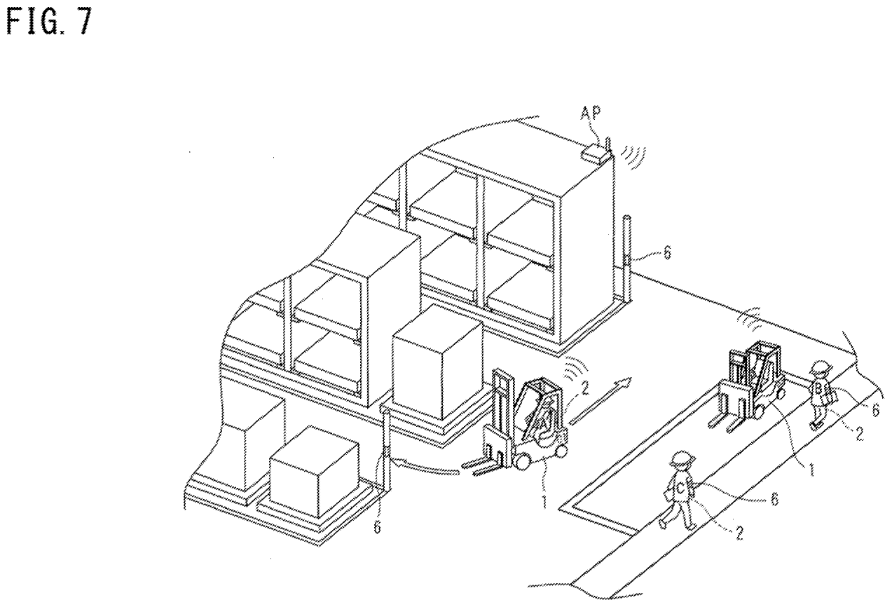

FIG. 7 illustrates the outline of a vehicle operation system of Embodiment 3. In Embodiment 3, a trigger for storing video data captured by the camera 4 is inclusion of a predetermined object in an imaging range of the camera 4. The predetermined object is, for example, a color label 6 that enables specifying a position in a work site. The color label 6 is colored by two or more colors in a unique positional relationship, and is attached to bars standing at various places in the work site as shown in FIG. 7. The color label 6 is also worn, like an arm band, by each of the operators A, B, C. Due to the colors of the color label 6 and the unique positional relationship thereof, label identification information can be specified. A fact that the color label 6 appears in a video based on a video signal received through the input unit 103 and label identification information has been able to be specified corresponds to a status of the forklift 1 that the forklift 1 has passed a specific position. Therefore, the on-vehicle apparatus 10 of Embodiment 3 stores video data by being triggered by this fact.

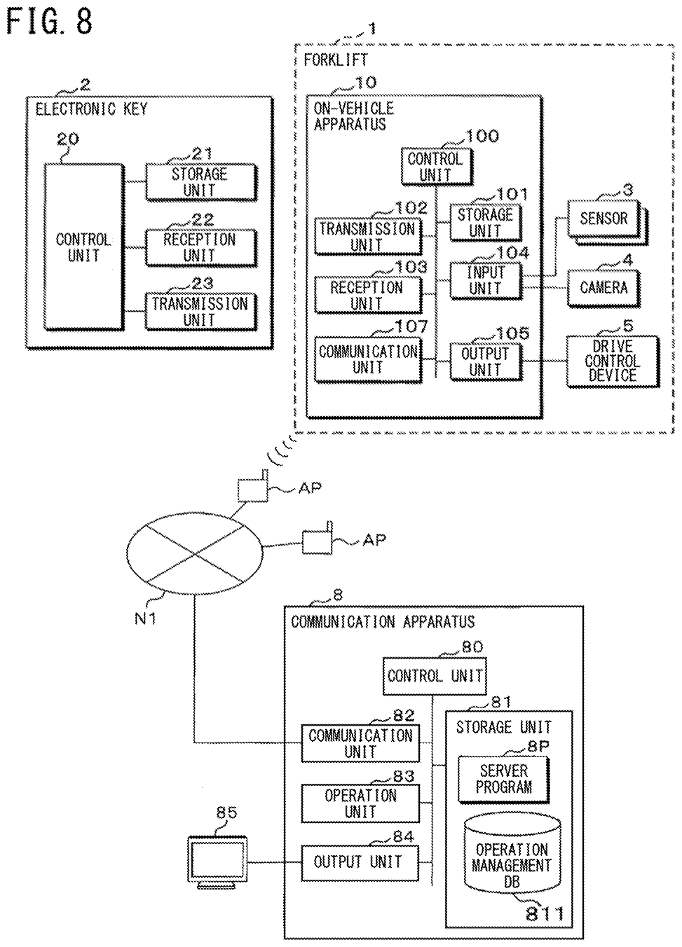

FIG. 8 is a block diagram showing a configuration of the vehicle operation system of Embodiment 3. In the vehicle operation system of Embodiment 3, the on-vehicle apparatus 10 includes a communication unit 107 that uses a module for wireless communication, and transmits and receives information to and from a communication apparatus 8 through wireless communication. Since the other configurations are the same as those in Embodiment 1, common configurations are denoted by the same reference signs as those in Embodiment 1, and detailed description thereof is omitted. In FIG. 8 and the description below, an example using the electronic key 2 of the passive radio wave type is described. However, the electronic key 2 and the on-vehicle apparatus 10 of the electromagnetic induction type may be used.

Using a wireless communication device according to Wi-Fi or the like, the communication unit 107 of the on-vehicle apparatus 10 in Embodiment 3 can be communicably connected to an in-plant network N1 via an access point AP provided in various places in the work site. The access points AP are provided at different places in a plant. The communication unit 107 may acquire information for identifying an access point to which the communication unit 107 is communicably connected. The communication unit 107 may be directly communicably connected to the communication apparatus 8. In this case, the communication unit 107 may use Bluetooth (registered trademark). As long as communication between the control unit 100 and the communication apparatus 8 is realized, any type of communication unit 107 may be employed.

The communication apparatus 8 is, for example, a PC (Personal Computer) to be used by a user having an authority as a manager in the work site. The communication apparatus 8 includes a control unit 80, a storage unit 81, a communication unit 82, an operation unit 83, and an output unit 84. The output unit is connected to a monitor 85.

The control unit 80 realizes various components by using a CPU. The control unit 80 performs a process procedure described later on the basis of a program stored in the storage unit 81 and operates as an operation management apparatus.

As the storage unit 81, a nonvolatile storage device such as a flash memory or a hard disk is used. A server program 8P is stored in the storage unit 81. The control unit 80 reads out and executes the server program 8P, thereby performing a process of recording into the storage unit 81 information transmitted from the on-vehicle apparatus 10, in association with vehicle identification information of the forklift 1 and operator identification information indicating the driver. Due to a process based on the server program 8P performed by the control unit 80, operation records of forklifts 1 at the work site aggregated from respective forklifts 1 are stored as an operation management DB 811 in the storage unit 81.

The communication unit 82 can be communicably connected to the in-plant network N1 in a wireless or wired manner. The control unit 80 can receive information transmitted from the on-vehicle apparatus 10, via the in-plant network N1 through the communication unit 82.

The operation unit 83 is a user interface such as a mouse or a keyboard. The control unit 80 performs a process in accordance with an operation detected at the operation unit 83. The output unit 84 is an interface for the monitor 85. The control unit 80 can output, to the monitor 85, an image of information stored in the storage unit 81 or of information received through the communication unit 82.

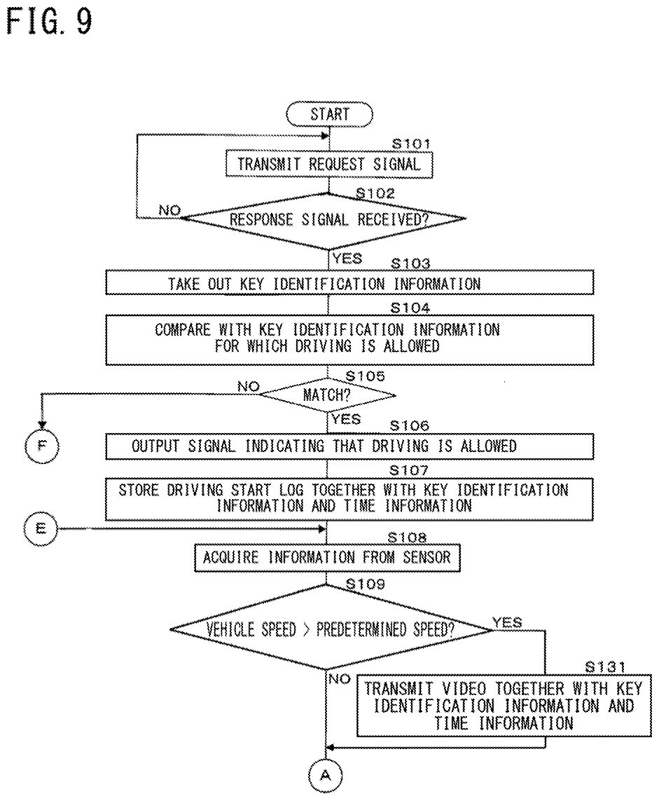

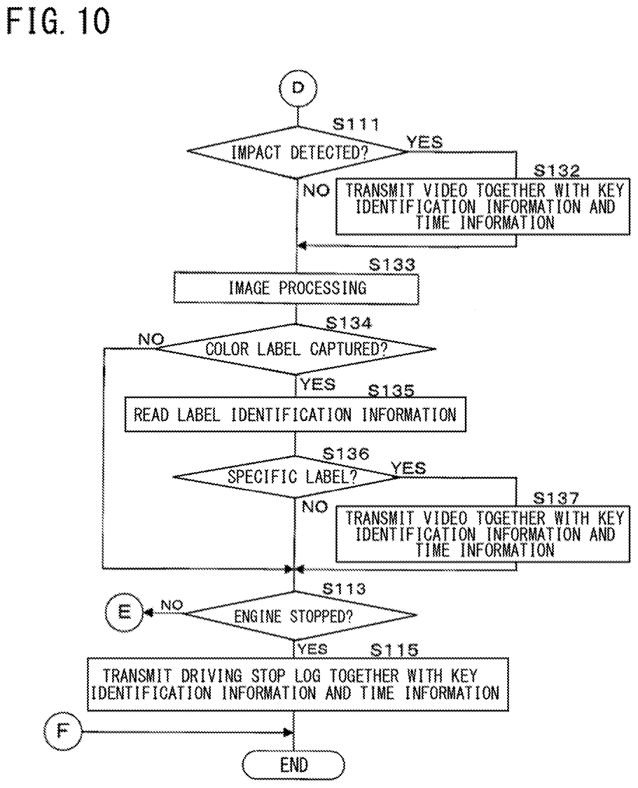

Capturing a video of the color label 6 in the vehicle operation system configured as above, and a storing process of video data triggered by the color label 6 are described. FIG. 9 and FIG. 10 are each a flow chart showing one example of a procedure of a video data storing process performed by the on-vehicle apparatus 10 of Embodiment 3. In the process procedure shown in the flow chart of FIG. 9 and FIG. 10, process steps that are the same as those in the flow chart in FIG. 3 of Embodiment 1 are denoted by the same step numbers, and detailed description thereof is omitted.

After outputting, to the drive control device 5, a signal indicating that driving is allowed (S106), the control unit 100 transmits, to the communication apparatus 8 through the communication unit 107, log data indicating that driving has started, in association with key identification information corresponding to the electronic key 2 held by the driver and time information (time stamp) acquired by the built-in timer (step S117). At least in the process of step S117 and further in a process thereafter, the control unit 100 preferably reads out from the storage unit 101 vehicle identification information for individually identifying a forklift 1, associates the read-out vehicle identification information with the information to be transmitted from the on-vehicle apparatus 10 to the communication apparatus 8, and transmits the resultant information.

Upon determining in step S109 that the vehicle speed has exceeded a predetermined speed (S109: YES), the control unit 100 transmits to the communication apparatus 8 through the communication unit 107, video data corresponding to a predetermined time in the video data received from the camera 4 and sequentially stored in the storage unit 101, in association with the key identification information and time information acquired by the built-in timer (step S131), and advances the process to step S111. In step S131, the control unit 100 may transmit information of trigger type indicating that overspeed has been used as a trigger.

Upon determining in step S111 that an impact has been detected (S111: YES), the control unit 100 transmits, to the communication apparatus 8 through the communication unit 107, video data corresponding to a predetermined time in the video data from the camera 4, in association with the key identification information and time information acquired by the built-in timer (step S132), and advances the process to step S133. In step S132, similar to step S131, the control unit 100 may transmit information of trigger type indicating that detection of an impact has been used as a trigger. Also upon determining in step S111 that no impact has been detected (S111: NO), the control unit 100 advances the process to step S133.

The control unit 100 performs image processing on a frame image included in the video data received from the camera 4 and sequentially stored in the storage unit 101 (step S133), and determines whether or not the color label 6 has been captured (step S134). The image processing in step S133 may be performed by an image processing IC (Integrated Circuit) which may be separately provided in the on-vehicle apparatus 10.

Upon determining that the color label 6 has been captured (S134: YES), the control unit 100 reads label identification information from the captured range of the color label 6 (step S135). Further, the control unit 100 determines whether or not the read label identification information corresponds to a specific label (step S136). The specific label is a bar label provided at a position where recording should be performed in the work site (in the plant) or a position of an important process, a bottleneck place, or the like in the work site. The label identification information of each specific label is stored in the storage unit 101 in advance. The label identification information of the specific label may be managed in the communication apparatus 8, and, in step S136, the control unit 100 may inquire of the communication apparatus 8 about whether or not the read label identification information corresponds to a specific label.

Upon determining in step S136 that the read label identification information corresponds to a specific label (S136: YES), the control unit 100 transmits, to the communication apparatus 8 through the communication unit 107, video data corresponding to a predetermined time in the video data received from the camera 4 and sequentially stored in the storage unit 101, in association with the key identification information and time information acquired by the built-in timer (step S137), and advances the process to step S113. Preferably, in step S137, the control unit 100 transmits the video data together with the label identification information read from the specific label.

Upon determining in step S134 that the color label 6 has not been captured (S134: NO), or upon determining in step S136 that the label identification information does not correspond to the specific label (S136: NO), the control unit 100 advances the process to step S113.

Upon determining in step S113 that the engine has stopped (S113: YES), the control unit 100 transmits, to the communication apparatus 8 through the communication unit 107, log data indicating that driving has ended, in association with the key identification information corresponding the electronic key 2 held by the driver and time information (time stamp) acquired by the built-in timer (step S115), and ends the process.

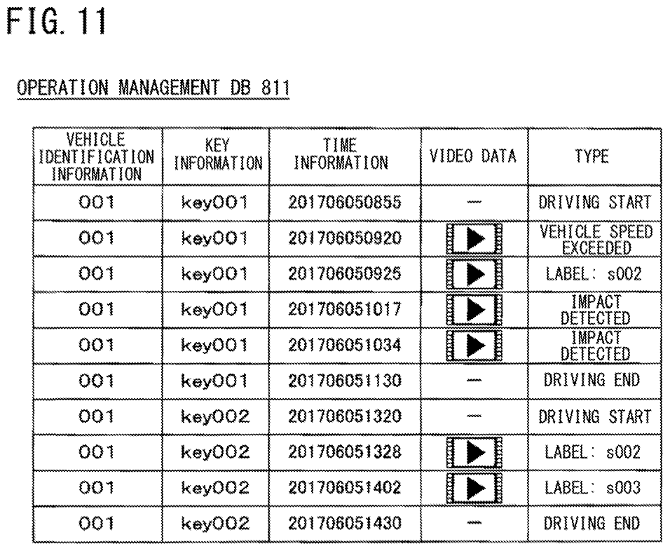

FIG. 11 illustrates an example of the content of information stored in the communication apparatus 8 of Embodiment 3. As shown in FIG. 11, in the communication apparatus 8, information received from the on-vehicle apparatus 10 is stored as the operation management DB 811. In the operation management DB 811, driving start and end logs and video data are stored together with their time information, in association with vehicle identification information of the forklift 1, the key information (key identification information) for which it was determined that driving was allowed. In the operation management DB 811 shown in FIG. 11, a trigger type is also associated. In particular, when label identification information that corresponds to a specific label has been read from the color label 6, the label identification information is stored. Accordingly, positions in time series of the forklift 1, i.e., a movement line in the work site, are stored in association with key information, i.e., information that specifies a driver. Thus, an extraction process of a movement line for each driver can be performed in a later time. In the example in FIG. 11, information of one forklift 1 is shown. However, with respect to a plurality of forklifts 1, information may be stored for each forklift 1.

In this manner, the on-vehicle apparatus 10 of Embodiment 3 performs image processing on video data (monitor) acquired from the camera 4, and stores video data into the external memory 106, triggered by whether or not a specific object for operation of the forklift 1 has been captured. Different from an external driving recorder that could be applied to a passenger car and for which an impact or an acceleration is merely used as a trigger, video data is stored, in Embodiment 3, triggered by a condition unique to an industrial vehicle, such as whether or not a specific object that enables specifying a position during traveling in the interior of a plant has been captured. Further, since the video data is stored with the driving operator identified, even if the operator drives a different forklift 1, the movement line (a set of positions) can be analyzed for each operator. Through these analyses, the number of forklifts 1 that should be deployed, the storing positions and storing amounts and deployment of goods as objects to be transferred, and further, deployment of operators, can be made appropriate.

### Embodiment 4

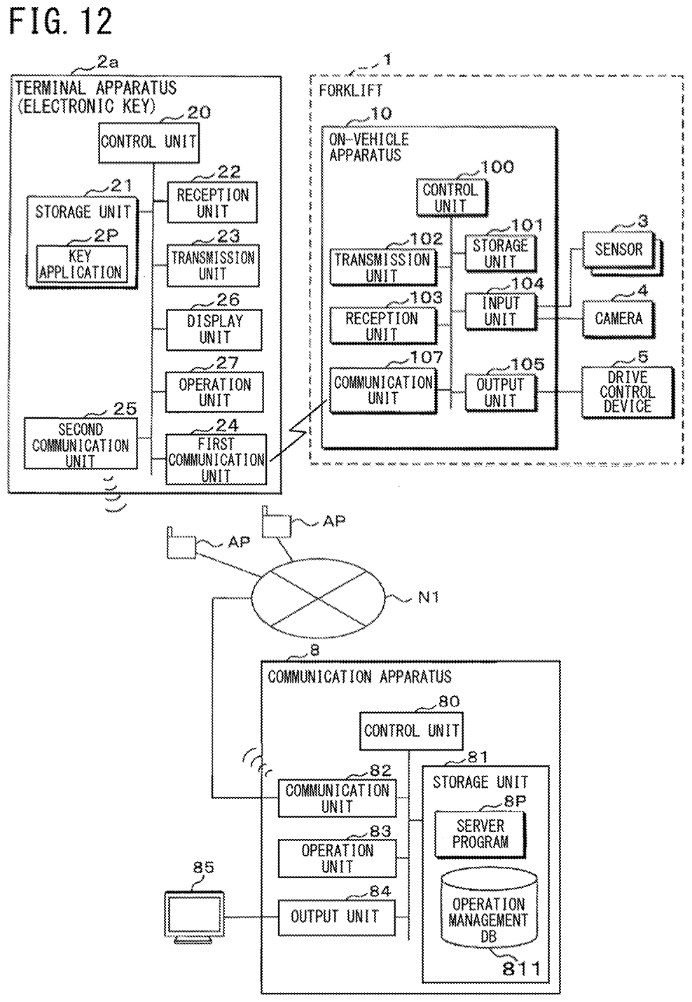

FIG. 12 is a block diagram showing a configuration of a vehicle operation system of Embodiment 4. In the vehicle operation system of Embodiment 4, the electronic key 2 is realized as one function of a terminal apparatus 2a. The terminal apparatus 2a performs communication with the communication apparatus 8, which is an external apparatus. Since the other configurations are the same as those in Embodiment 1, common configurations are denoted by the same reference signs as those in Embodiment 1, and detailed description thereof is omitted. In FIG. 12 and the description below, an example of a signal transmission/reception procedure of the passive radio wave type is described.

In Embodiment 4, the communication unit 107 of the on-vehicle apparatus 10 operates as a communication module which directly communicates with the terminal apparatus 2a. In this case, the communication unit 107 uses Bluetooth (registered trademark). The communication unit 107 may be a communication module based on another standard that can establish communication connection with the terminal apparatus 2a.

The terminal apparatus 2a is obtained by providing LF band and UHF band antennas to a so-called smartphone. The terminal apparatus 2a includes a control unit 20, a storage unit 21, a reception unit 22, a transmission unit 23, a first communication unit 24, a second communication unit 25, a display unit 26, and an operation unit 27.

The control unit 20 includes a CPU, a ROM, a clock, and the like. On the basis of various programs including a key application (application program) 2P stored in the storage unit 21, the control unit 20 causes the terminal apparatus 2a, which is a general-purpose computer, to operate as a specific processing apparatus that exhibits the function of the electronic key 2 as described later.

The storage unit 21 includes a non-volatile memory such as a flash memory. The storage unit 21 has stored therein in advance various programs including the key application 2P, and unique identification information that identifies the terminal apparatus 2a itself In the storage unit 21, operator identification information (operator ID) that identifies the operator holding the terminal apparatus 2a and the key application 2P are stored in association with each other. In Embodiment 4, the unique identification information may be used also as key identification information. However, in the description below, the operator identification information is used as information for determining whether or not driving is allowed.

The reception unit 22 and the transmission unit 23 are the same as those in the electronic key 2 of the passive type in Embodiment 1. A module that includes an antenna of an LF band to a VLF band and a demodulator connected to the antenna, and a module that includes an antenna of a UHF band and a modulator connected to the antenna are provided in the housing of the terminal apparatus 2a, which is a smartphone. The modules can be controlled by the control unit 20.

The first communication unit 24 is a communication module communicably connected to the communication unit 107 of the on-vehicle apparatus 10, and uses Bluetooth (registered trademark), for example. A communication module based on another standard may be used as long as the communication module corresponds to the communication unit 107.

The second communication unit 25 is a wireless communication device according to Wi-Fi or the like, and realizes communication connection with the in-plant network N1 via an access point AP.

The display unit 26 is a touch-panel-built-in-type display which uses a display such as a liquid crystal display or an organic EL (Electro Luminescence) display. On the basis of a process performed by the control unit 20, the display unit 26 displays various types of information, such as a button for receiving an application based on the key application 2P.

The operation unit 27 is physical buttons provided to the housing of the apparatus and the touch panel built in the display unit 26. Alternatively, the operation unit 27 may be a device (keyboard, pointing device) that receives an operation input by a user.

In the terminal apparatus 2a configured as above, for example, when an operator performs an operation of activating the key application 2P, the control unit 20 reads out and executes the key application 2P, and causes a signal instructing locking or unlocking to be outputted from the transmission unit 23. In this manner, the terminal apparatus 2a can exhibit the function as the electronic key 2. In the present Embodiment 2, it is assumed that the storage unit 101 of the on-vehicle apparatus 10 has stored therein operator identification information (operator ID) as the key information for determining that driving is allowed. In a case where the terminal apparatus 2a in which the key application 2P has been activated responds to a request signal from the on-vehicle apparatus 10 and the operator identification information stored in association with the key application 2P matches information for which it is determined that driving is allowed for the target forklift 1, the on-vehicle apparatus 10 permits driving.

In Embodiment 2, the server program 8P stored in the storage unit 81 of the communication apparatus 8 is a program that corresponds to the key application 2P (client program) in the terminal apparatus 2a.

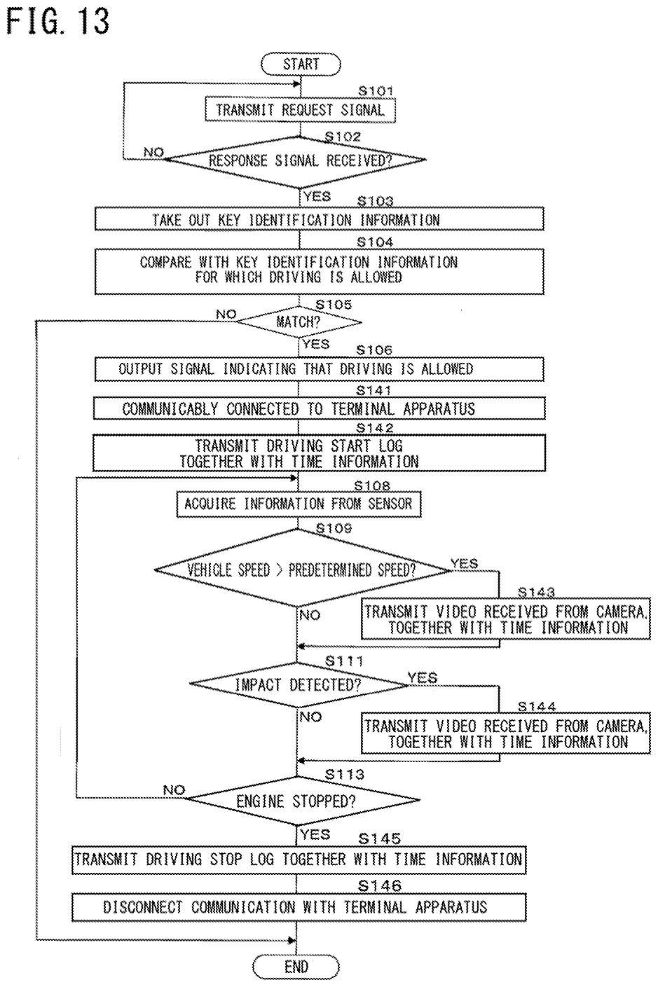

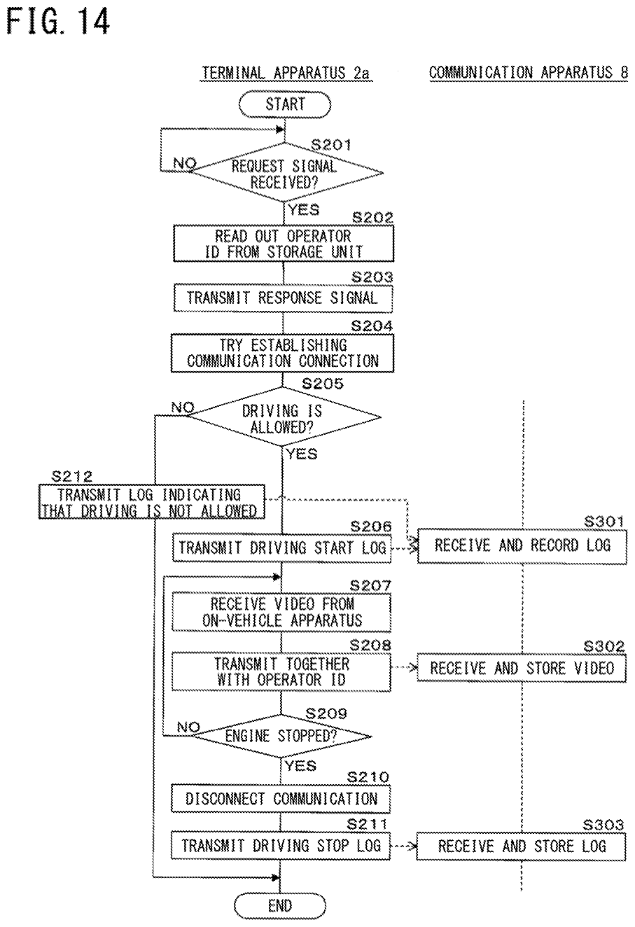

FIG. 13 and FIG. 14 are each a flow chart showing one example of a procedure of a storing process performed by the on-vehicle apparatus 10 of Embodiment 4. FIG. 13 shows a process procedure on the on-vehicle apparatus 10 side. FIG. 14 shows a process procedure in the terminal apparatus 2a and the communication apparatus 8. In the process procedure on the on-vehicle apparatus 10 side shown in the flow chart of FIG. 13, process steps that are the same as those in the flow chart in FIG. 3 of Embodiment 1 are denoted by the same step numbers, and detailed description thereof is omitted.

When the control unit 100 of the on-vehicle apparatus 10 transmits a request signal (S101) and determines that a response signal to the request signal has been received (S102: YES), the control unit 100 takes out key information (operator ID) included in the received response signal (S103). In addition, if unique information or the like is included, the control unit 100 may also take out this information. The request signal transmitted in step S101 may include connection information for allowing the terminal apparatus 2a to be communicably connected to (paired with) the on-vehicle apparatus 10. Alternatively, fixed connection information may be set in advance in the on-vehicle apparatus 10, and this fixed connection information may be registered on the terminal apparatus 2a side in advance.

The control unit 100 compares the key information taken out in step S103, i.e., compares the operator identification information of the operator who is to drive, with operator identification information which is stored in the storage unit 101 and for which it is to be determined that driving is allowed (S104). Then, the control unit 100 determines whether or not the taken-out operator identification information matches the operator identification information for which it is to be determined that driving is allowed (step S105). After the control unit 100 determines in step S105 that there is matching therebetween (S105: YES) and outputs a signal indicating that driving is allowed, through the output unit 5 toward the drive control device 5 (S106), the control unit 100 establishes communication connection with the terminal apparatus 2a through the communication unit 107 (step S141). The control unit 100 transmits a log indicating start of driving in association with time information, toward the terminal apparatus 2a to which the control unit 100 is communicably connected (step S142), and then, advances the process to step S108. In step S142, vehicle identification information may also be transmitted in association therewith.

Then, the control unit 100 acquires information from the sensor-3 group (S108), and determines whether or not the vehicle speed acquired from the vehicle speed sensor has exceeded a predetermined speed (S109). Upon determining that the vehicle speed has exceeded the predetermined speed (S109: YES), the control unit 100 transmits, to the terminal apparatus 2a, video data corresponding to a predetermined time in the video data received from the camera 4 and sequentially stored in the storage unit 101, in association with time information acquired by the built-in timer (step S143), and advances the process to step S111.

Also upon determining in step S111 that an impact has been detected (S111: YES), the control unit 100 transmits video data in association with time information, to the terminal apparatus 2a (step S144), and advances the process to step S113.

Further, upon determining in step S113 that the engine has stopped (S113: YES), the control unit 100 transmits, to the terminal apparatus 2a to which the control unit 100 is communicably connected, log data indicating that driving has ended, in association with time information acquired by the built-in timer (step S145). In step S145, the control unit 100 may also transmit the vehicle identification information in association therewith. Then, the control unit 100 disconnects the communication with the terminal apparatus 2a (step S146), and ends the process.

With reference to the flow chart in FIG. 14, communication between the terminal apparatus 2a and the communication apparatus 8 is described. The control unit 20, of the terminal apparatus 2a, which operates as the electronic key 2, determines whether or not a request signal from the on-vehicle apparatus 10 has been received (step S201). Upon determining that the request signal has not been received (S201: NO), the control unit 20 returns the process to step S201. Upon determining that the request signal has been received (S201: YES), the control unit 20 reads out operator identification information stored in the storage unit 21 (step S202). The control unit 20 causes a response signal that includes the read-out operator identification information as key information, to be transmitted from the transmission unit 23 toward the on-vehicle apparatus 10 (step S203).

The control unit 20 of the terminal apparatus 2a tries establishing communication connection with the on-vehicle apparatus 10 via the first communication unit 24 (step S204), and determines whether or not driving is allowed in accordance with whether or not the connection has been established (step S205). The determination as to whether or not driving is allowed may be made in accordance with whether or not communication connection has been established and a start log has been received.

Upon determining that driving is allowed (S205: YES), the control unit 20 transmits, to the communication apparatus 8 through the second communication unit 25, log data indicating start of driving, in association with the vehicle identification information of the on-vehicle apparatus 10 as the transmission source, and further, the operator identification information (step S206). Thereafter, the control unit 20 of the terminal apparatus 2a receives video data transmitted together with time information during driving from the on-vehicle apparatus 10, through the first communication unit 24 communicably connected therewith (step S207). The control unit 20 transmits, to the communication apparatus 8 through the second communication unit 25, the received video data and time information, in association with the operator identification information (step S208). The transmission in step S208 may be performed every time information is received from the on-vehicle apparatus 10. Alternatively, information from the on-vehicle apparatus 10 may be temporarily stored in the storage unit 21, and then the information may be periodically read out and transmitted.

The control unit 20 determines whether or not the engine (or drive motor) of the forklift 1 has stopped (step S209). Upon determining that log data indicating end of driving has not been received and the engine has not stopped (S209: NO), the control unit 20 returns the process to step S207, and repeats reception of information.

Upon determining that the engine has stopped (S209: YES), the control unit 20 disconnects the communication with the on-vehicle apparatus 10, by disabling the first communication unit 24, for example (step S210). The control unit 20 transmits, to the communication apparatus 8 through the second communication unit 25, the received log data indicating stop of driving and time information, in association with the vehicle identification information and the operator identification information (step S211), and ends the process.

When having determined in step S205 that driving is not allowed (S205: NO), i.e., when communication connection has not been established, the control unit 20 transmits log data indicating that driving is not allowed, to the communication apparatus 8 through the second communication unit 25 (step S212), and ends the process. At this time, for example, the control unit 20 may cause a message indicating that driving is not permitted to be displayed on the screen of the key application 2P in the display unit 26.

On the communication apparatus 8 side, when log data indicating start of driving and time information have been transmitted from the terminal apparatus 2a, the control unit 80 receives these pieces of information through the communication unit 82 and stores, into the operation management DB 811, these pieces of information in association with the operator identification information (operator ID) transmitted in association therewith (step S301). When the received log data indicates that driving is not allowed, the control unit 80 stores the log data and ends the process.

Every time video data is transmitted together with time information from the terminal apparatus 2a, the control unit 80 receives the video data in association with the time information, the operator identification information, and the vehicle identification information, and stores these pieces of information into the operation management DB 811 (step S302).

Then, when log data indicating stop of driving has been transmitted from the terminal apparatus 2a, the control unit 80 receives the log data through the communication unit 82, and stores the log data, into the operation management DB 811, in association with the operator identification information and the vehicle identification information, together with the time information (step S303).

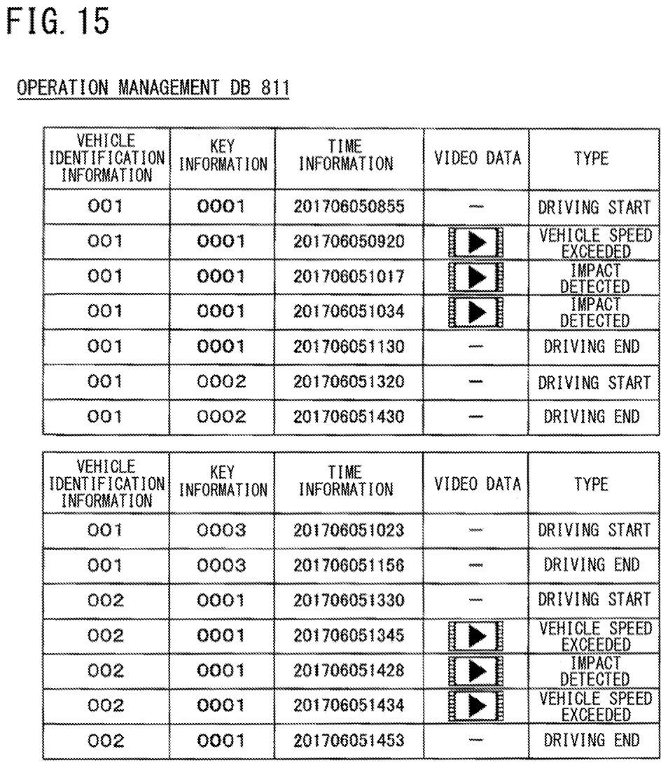

FIG. 15 illustrates an example of the content of information stored in the communication apparatus 8 of Embodiment 4. In the operation management DB 811 of Embodiment 4, for each forklift 1, driving start and end logs and video data are stored together with their time information, in association with vehicle identification information, the key information for which it was determined that driving was allowed (operator identification information). Thus, on the basis of the operator identification information, driving record can be extracted for each vehicle and for each operator. In addition, in the operation management DB 811 shown in FIG. 15, the trigger type is also associated.

Thus, since video data captured by each forklift 1 is aggregated in the communication apparatus 8, it becomes possible to comprehensively analyze video data for a plurality of forklifts 1 stored in the operation management DB 811, a posteriori or in real time. Since video data is automatically stored for each driver holding an electronic key 2 (terminal apparatus 2a), even if the same operator drives different forklifts 1, data for analyzing driving tendency can be recorded as a video. When analysis is performed with respect to a plurality of forklifts 1 operated in the same work site, it becomes possible to present the number of forklifts 1 that should be deployed at the work site, storing positions, storing amounts, and appropriate deployment of goods as objects to be transferred, or the like. Thus, various applications can be realized. In addition, if analysis is performed in real time, it is possible to provide driving support such as presentation of a more efficient movement line.

In Embodiment 4, the on-vehicle apparatus 10 is configured to receive key information from the electronic key 2, through the reception unit 103 which is used for transmission/reception of a request signal. However, acquisition of key information is not limited to transmission/reception of a radio signal of a UHF band or the like. For example, the following configuration may be employed. That is, the terminal apparatus 2a encrypts key information, then makes a two-dimensional bar code of the encrypted key information, and causes the two-dimensional bar code to be displayed on the display unit 26. Then, the on-vehicle apparatus 10 causes the camera 4 to capture an image of the display unit 26 of the terminal apparatus 2a, and performs image processing on a video signal thereof, thereby acquiring the key information from the two-dimensional bar code. Other than this, the terminal apparatus 2a may have a radio tag having key information stored therein, and the on-vehicle apparatus 10 may acquire the key information read by use of a reader that reads the key information from the radio tag. Still alternatively, the terminal apparatus 2a may output key information in terms of characters or sound, and on the on-vehicle apparatus 10 side, the key information may be read by the camera 4, or received via a microphone to be recognized.

The electronic key 2 in Embodiments 2 and 3 may also be realized by the terminal apparatus 2a. When performing the video data storing process in Embodiment 2 that uses information from the sensor-3 group as a trigger, or when performing the video data storing process in Embodiment 3 that uses a result of image processing on video data as a trigger, key identification information and other information acquired from the terminal apparatus 2a are stored together. Alternatively, the video data storing process in Embodiment 2 that uses information from the sensor-3 group as a trigger, and the video data storing process in Embodiment 3 that uses a result of image processing on video data as a trigger may each be performed in the communication apparatus 8 via the terminal apparatus 2a of Embodiment 4.

The disclosed embodiments are merely illustrative in all aspects and should not be recognized as being restrictive. The scope of the present disclosure is defined by the scope of the claims rather than by the description above, and is intended to include meaning equivalent to the scope of the claims and all modifications within the scope.

### REFERENCE SIGNS LIST

1 forklift (industrial vehicle)

10 on-vehicle apparatus

100 control unit

101 storage unit

102 transmission unit

103 reception unit

104 input unit

105 output unit

106 external memory

107 communication unit

2 electronic key

2a terminal apparatus

20 control unit

21 storage unit

22 reception unit

23 transmission unit

24 first communication unit

25 second communication unit

26 display unit

27 operation unit

2P key application

3 sensor

31 antenna coil

32 ignition (IG) switch

3a vehicle speed sensor

3b acceleration sensor

3c weight sensor

3d infrared sensor

3e reader

4 camera

5 drive control device

6 color label

8 communication apparatus

80 control unit

81 storage unit

82 communication unit

83 operation unit

84 output unit

85 monitor

8P server program

811 operation management DB

N1 network

AP access point

1. An operation system for an industrial vehicle, the operation system comprising:
a plurality of electronic keys; and
an on-vehicle apparatus mounted on an industrial vehicle and configured to transmit and receive a signal to and from the plurality of electronic keys, wherein
the plurality of electronic keys each
have key information stored therein, and
include an output unit configured to output the key information toward the on-vehicle apparatus,
the on-vehicle apparatus includes
an acquisition unit configured to acquire key information outputted from the plurality of electronic keys,
a determination unit configured to determine, on the basis of the acquired key information, whether or not driving of the industrial vehicle having the on-vehicle apparatus mounted thereon is allowed, and
an input unit configured to receive a video signal from an imaging apparatus configured to capture a video of a periphery of the industrial vehicle, and
when the determination unit has determined that the driving is allowed, the on-vehicle apparatus stores the video corresponding to a predetermined time and captured by the imaging apparatus, in association with the key information, on the basis of a timing of a trigger which is a measurement result by a status measurement unit configured to measure a status of the industrial vehicle.

2. The operation system according to claim 1, wherein
the status measurement unit includes at least one of a vehicle speed sensor, an acceleration sensor, a weight sensor, or an infrared sensor.

3. The operation system according to claim 1, wherein
the industrial vehicle is a forklift, and the status measurement unit includes a weight sensor provided at a fork portion of the forklift and configured to measure a weight of an object to be transported, and
the on-vehicle apparatus stores the video corresponding to the predetermined time, using a change in the measured weight as a trigger.

4. The operation system according to claim 1, wherein
the on-vehicle apparatus
further includes an image processing unit configured to perform image processing on the video signal from the imaging apparatus, and
stores the video corresponding to the predetermined time when, as a result of image processing performed by the image processing unit, it is determined that a specific object or person has been captured in a video based on the video signal.

5. The operation system according to claim 1, further comprising
a communication apparatus configured to receive the video corresponding to the predetermined time, through communication from the on-vehicle apparatus or via the electronic key, wherein
the communication apparatus includes a storage unit configured to store the received video in association with: vehicle identification information of the industrial vehicle having the on-vehicle apparatus mounted thereon; and driver identification information of a driver specified from the key information.

6. An on-vehicle apparatus comprising:
an acquisition unit configured to acquire key information outputted from a plurality of electronic keys;
a determination unit configured to determine, on the basis of the acquired key information, whether or not driving of an industrial vehicle having the on-vehicle apparatus mounted thereon is allowed;
an input unit configured to receive a video signal from an imaging apparatus configured to capture a video of a periphery of the industrial vehicle; and
a storage medium configured to store, when the determination unit has determined that the driving is allowed, the video corresponding to a predetermined time and captured by the imaging apparatus, in association with the key information, on the basis of a timing of a trigger which is a measurement result by a status measurement unit configured to measure a status of the industrial vehicle.

7. An industrial vehicle having the on-vehicle apparatus according to claim 6 mounted thereon.

8. A forklift having the on-vehicle apparatus according to claim 6 mounted thereon.

9. A non-transitory computer readable storage medium storing a computer program configured to cause a computer which receives a video signal from an imaging apparatus, to perform processes of:
acquiring key information outputted from a plurality of electronic keys;
determining, on the basis of the acquired key information, whether or not driving of an industrial vehicle having the computer mounted thereon is allowed;
measuring a status of the industrial vehicle when it has been determined that the driving is allowed; and
storing a video corresponding to a predetermined time and captured by the imaging apparatus, in association with the key information, on the basis of a timing of a trigger which is a measurement result.

10. A non-transitory computer readable storage medium storing industrial vehicle operation data,
a data structure of the industrial vehicle operation data including
on-vehicle-apparatus-side key information configured to be used in an on-vehicle apparatus mounted on each of a plurality of industrial vehicles and to be stored for each industrial vehicle, and
video data acquired from an imaging apparatus configured to capture a video of a periphery of the industrial vehicle,
the data structure being configured to be used in processes of:
acquiring key information outputted from a plurality of electronic keys;
determining, on the basis of a correspondence with the acquired key information, whether or not driving of the industrial vehicle is allowed; and
when it has been determined that the driving is allowed, storing the video, in the video data, that corresponds to a predetermined time based on a timing of a trigger, into a storage medium in association with the key information, the trigger being a measurement result by a status measurement unit configured to measure a status of the industrial vehicle.

11. An operation method using a plurality of electronic keys and an on-vehicle apparatus mounted on an industrial vehicle and configured to transmit and receive a signal to and from the plurality of electronic keys, the operation method comprising:
the plurality of electronic keys each having key information stored therein and outputting the key information toward the on-vehicle apparatus; and
the on-vehicle apparatus
receiving a video signal from an imaging apparatus configured to capture a video of a periphery of the industrial vehicle and sequentially storing the video signal,
when having acquired key information outputted from the plurality of electronic keys, determining whether or not driving of the industrial vehicle having the on-vehicle apparatus mounted thereon is allowed, on the basis of the acquired key information, and
when having determined that the driving is allowed, storing the video, in the sequentially stored video signal, that corresponds to a predetermined time based on a timing of a trigger, in association with the key information, the trigger being a measurement result by a status measurement unit configured to measure a status of the industrial vehicle.
